(19) United States
(12) Patent Application Publication
(10) Pub. No.: US 2026/0128492 A1
(43) Pub. Date: May 7, 2026

(54) Dielectric Waveguide Cable For High Data Rate Communications

(71) Applicant: MediaTek Inc., Hsinchu City (TW)

(72) Inventors: Sang-June Park, San Jose, CA (US); Gurkaranjot Singh Kalra, San Jose, CA (US); Saeed Farsi, San Jose, CA (US); Hsin-Hung Chen, San Jose, CA (US)

(21) Appl. No.: 19/187,951

(22) Filed: Apr. 23, 2025

Related U.S. Application Data
(60) Provisional application No. 63/716,758, filed on Nov. 6, 2024.

(51) Int. Cl. H01P 3/16

(52) U.S. Cl. CPC H01P 3/16

(57) ABSTRACT

Techniques pertaining to designs of a dielectric waveguide (DWG) cable for high data rate communications are described. A DWG cable is configured to carry multiple data streams to support a high data rate communication. The DWG cable includes a cladding material and a plurality of cores with each core of the plurality of cores surrounded by the cladding material.

### CROSS REFERENCE TO RELATED PATENT APPLICATION(S)

The present disclosure is part of a non-provisional application claiming the priority benefit of U.S. patent application Ser. No. 63/716,758, filed 6 Nov. 2024, the content of which herein being incorporated by reference in its entirety.

### TECHNICAL FIELD

The present disclosure is generally related to wireline communications and, more particularly, to designs of a dielectric waveguide (DWG) cable for high data rate communications.

### BACKGROUND

Unless otherwise indicated herein, approaches described in this section are not prior art to the claims listed below and are not admitted as prior art by inclusion in this section.

The server system performance in data centers play a key role in the rapid advancement of artificial intelligence. The network within the data centers connects a large number of servers through high-speed links and switches. Conventional chip-to-chip communication in data centers, applications typically use electrical and optical channels/links. The electrical channel or link in general has a large roll-off in the insertion loss over bandwidth, thereby requiring power-hungry equalization. The optical channel or link, on the other hand, typically has very small roll-off, but tends to be expensive solution since it requires electrical to optical conversion. In contrast, the dielectric waveguide (DWG) cables offer performance advantage over electrical links and cost advantage over optical links for a medium range of 1-10 meters of distance. Compared to copper, the DWG losses are lower and the bandwidth achievable is higher. Compared to optical links, DWGs tend to be cheaper and more mechanically robust. One use-case of DWG cable is to connect a graphics processing unit (GPU) (e.g., inside a server) to a switch-integrated circuit (IC) (e.g., inside an ethernet switch). Therefore, there is a need for a solution of designs of a DWG cable for high data rate communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to designs of a DWG cable for high data rate communications. It is believed that implementations of the various proposed schemes may address or otherwise alleviate the aforementioned issue(s).

In one aspect, a device may include a DWG cable configured to carry multiple data streams to support a high data rate communication. The DWG cable may include a cladding material and a plurality of cores with each core of the plurality of cores surrounded by the cladding material.

In another aspect, an apparatus may include two IC chips (e.g., a GPU and a switch-IC) and a DWG cable. The DWG cable may be configured to carry multiple data streams to support a high data rate communication. The DWG cable may include a cladding material and a plurality of cores with each core of the plurality of cores surrounded by the cladding material.

It is noteworthy that, although description provided herein may be in the context of certain radio access technologies, networks, and network topologies for wireless communication, such as 5^{th} Generation (5G)/New Radio (NR) mobile communications, 6^{th} Generation (6G) mobile communications and beyond, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of example design under a proposed scheme in accordance with an implementation of the present disclosure.

FIG. 2 is a diagram of example design under a proposed scheme in accordance with an implementation of the present disclosure.

FIG. 3 is a diagram of example design under a proposed scheme in accordance with an implementation of the present disclosure.

FIG. 4 is a diagram of example design under a proposed scheme in accordance with an implementation of the present disclosure.

FIG. 5 is a diagram of example design under a proposed scheme in accordance with an implementation of the present disclosure.

FIG. 6 is a diagram of example scenario under a proposed scheme in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to designs of a DWG cable for high data rate communications. According to the present disclosure, a number of possible solutions may be implemented separately or jointly. That is, although these possible solutions may be described below separately, two or more of these possible solutions may be implemented in one combination or another.

Twin-axial copper cables are extensively used in data centers to establish the connections between servers and switches, using a Serializer-Deserializer (SerDes) chipset. Differential signaling is preferred over single-ended transmission, making the interface resistant to noise. The two conductors (cables) need to be kept close together, with a constant separation along the full length of the cables, so as to ensure consistent coupling and impedance. However, the cost of electrical interconnects is rather significant, especially given the requirement of small dimensional accuracy that is necessary in the cable. A recent trend in the electrical interconnects is 224 Gbps data rate with 4-level pulse amplitude modulation (PAM4), and the Nyquist frequency for the 224 Gbps is 56 GHz. Correspondingly, the insertion loss roll-off from 0 Hz till 56 GHz is significantly large (e.g., up to 45 dB) for a channel length of 3 meters. Consequently, this requires power-hungry equalization to compensate the channel loss in order to achieve a good bit-error-rate (BER).

On the other hand, optical interconnects have the advantage that high-speed signals can be transmitted further than in an electrical one with low propagation loss. Thus, active optical cables (AOCs) have been widely applied for rack-to-rack data transmission in data centers. Optical links require non-silicon devices to generate the signal, but this tends to increase the cost and power dissipation. In an AOC, a vertical cavity surface emitting laser (VCSEL), a photodiode (PD), a VCSEL driver, and a transimpedance amplifier (TIA) integrated circuit (IC) are mounted on the backside of a multi-layer organic substrate. To support 800 Gbps bi-directional link, the number of Laser/Laser driver /hotodiode/TIA required are typically 8 each. As a result, these non-silicon devices tend to be very expensive.

In view of the above, various designs of a dielectric waveguide cable are proposed in the present disclosure, as described below.

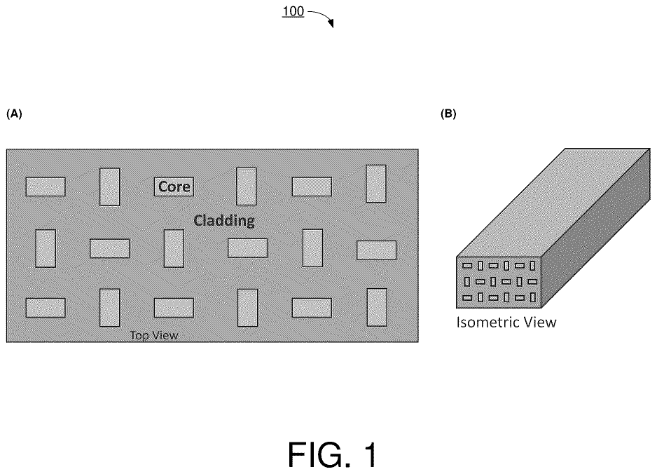

FIG. 1 illustrates an example design 100 of a DWG cable under a proposed scheme in accordance with the present disclosure. Part (A) of FIG. 1 shows a top view, or cross-sectional view, of the DWG cable under the proposed scheme. Part (B) of FIG. 1 shows an isometric view of the DWG cable. In design 100, a DWG cable may include a plurality of cores (or core dielectrics) disposed in a cladding with each core electrically isolated from other cores by the cladding. The profile or shape of the cross section of the DWG cable in design 100 may be square, rectangular or circular (round) in general. Referring to FIG. 1, each core may be placed at a 90° angle relative to its adjacent cores (e.g., those cores that are directly above, below, to the left, and to the right of the given core as shown in a top view or cross-sectional view of the DWG cable in FIG. 1) while being at a 0° angle relative to its diagonal cores (e.g., those cores that are to the upper-left, upper-right, lower-left, and lower-right of the given core as shown in a top view or cross-sectional view of the DWG cable in FIG. 1). That is, as the cross section of each core may have a generally elongated or rectangular shape with two longer sides and two shorter sides, in the cross-sectional view of the DWG cable each core may be oriented at 90° relative to (e.g., perpendicular to) its adjacent cores and at 0° relative to (e.g., parallel to) its diagonal cores. The center-to-center spacing between two adjacent cores may be chosen to achieve a good electrical isolation. The material of the cladding may be chosen to provide sufficient protection of the cores against external contact while providing insulation/isolation. Moreover, cladding dielectric may be filled everywhere else in the entire cable for ease of manufacturability. In design 100, the structure of the DWG cable may provide a tight control over core locations, thereby resulting in a good isolation for long distance with twisting and/or bending of the DWG cable.

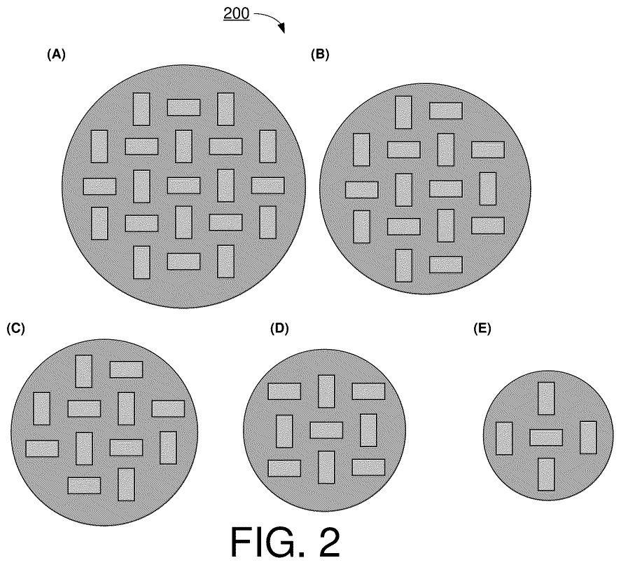

FIG. 2 illustrates an example design 200 of a DWG cable under a proposed scheme in accordance with the present disclosure. Each of parts (A), (B), (C), (D) and (E) of FIG. 2 shows a respective top view, or cross-sectional view, of the DWG cable under the proposed scheme. In design 200, a DWG cable may include a plurality of cores (or core dielectrics) disposed in a cladding with each core electrically isolated from other cores by the cladding. The profile or shape of the cross section of the DWG cable in design 200 may be round or circular in general. Referring to FIG. 2, each core may be placed at a 90° angle relative to its adjacent cores (e.g., those cores that are directly above, below, to the left, and to the right of the given core as shown in a top view or cross-sectional view of the DWG cable in FIG. 2) while being at a 0° angle relative to its diagonal cores (e.g., those cores that are to the upper-left, upper-right, lower-left, and lower-right of the given core as shown in a top view or cross-sectional view of the DWG cable in FIG. 2). That is, as the cross section of each core may have a generally elongated or rectangular shape with two longer sides and two shorter sides, in the cross-sectional view of the DWG cable each core may be oriented at 90° relative to (e.g., perpendicular to) its adjacent cores and at 0° relative to (e.g., parallel to) its diagonal cores. The center-to-center spacing between two adjacent cores may be chosen to achieve a good electrical isolation. The material of the cladding may be chosen to provide sufficient protection of the cores against external contact while providing insulation/isolation. Moreover, cladding dielectric may be filled everywhere else in the entire cable for ease of manufacturability. In design 200, the structure of the DWG cable may provide a tight control over core locations, thereby resulting in a good isolation for long distance with twisting and/or bending of the DWG cable.

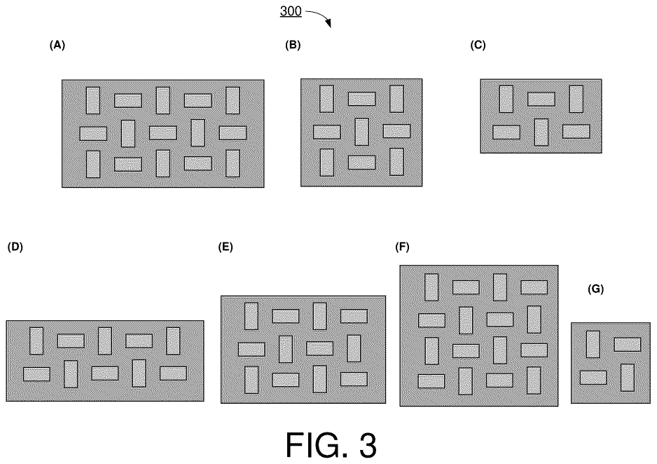

FIG. 3 illustrates an example design 300 of a DWG cable under a proposed scheme in accordance with the present disclosure. Each of parts (A), (B), (C), (D), (E), (F) and (G) of FIG. 3 shows a respective top view, or cross-sectional view, of the DWG cable under the proposed scheme. In design 300, a DWG cable may include a plurality of cores (or core dielectrics) disposed in a cladding with each core electrically isolated from other cores by the cladding. The profile or shape of the cross section of the DWG cable in design 300 may be square, rectangular or circular (round) in general. Referring to FIG. 3, each core may be placed at a 90° angle relative to its adjacent cores (e.g., those cores that are directly above, below, to the left, and to the right of the given core as shown in a top view or cross-sectional view of the DWG cable in FIG. 3) while being at a 0° angle relative to its diagonal cores (e.g., those cores that are to the upper-left, upper-right, lower-left, and lower-right of the given core as shown in a top view or cross-sectional view of the DWG cable in FIG. 3). That is, as the cross section of each core may have a generally elongated or rectangular shape with two longer sides and two shorter sides, in the cross-sectional view of the DWG cable each core may be oriented at 90° relative to (e.g., perpendicular to) its adjacent cores and at 0° relative to (e.g., parallel to) its diagonal cores. The center-to-center spacing between two adjacent cores may be chosen to achieve a good electrical isolation. The material of the cladding may be chosen to provide sufficient protection of the cores against external contact while providing insulation/isolation. Moreover, cladding dielectric may be filled everywhere else in the entire cable for ease of manufacturability. In design 300, the structure of the DWG cable may provide a tight control over core locations, thereby resulting in a good isolation for long distance with twisting and/or bending of the DWG cable. Moreover, in design 300, the DWG cable may have an even or odd number of cores such as, for example, and not limited to, 4 or 6 or 8 or 9 or 10 or 12 or 14 or 16 or 18 or 20 or 22 cores, and so on, with some of which shown in FIG. 3.

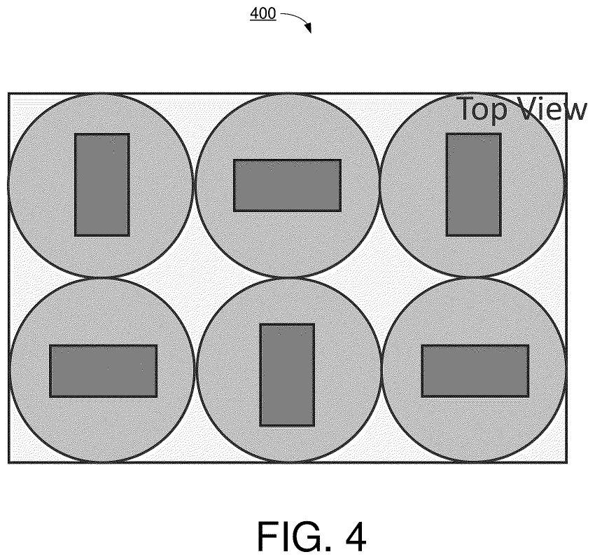

FIG. 4 illustrates an example design 400 of a DWG cable under a proposed scheme in accordance with the present disclosure. Specifically, FIG. 4 shows a top view, or cross-sectional view, of the DWG cable under the proposed scheme. In design 400, a DWG cable may include a plurality of cores (or core dielectrics) each of which being disposed in a respective cladding so as to be electrically isolated from other cores by the cladding. That is, in design 400, each core may be individually cladded by its respective cladding. The profile or shape of the cross section of the DWG cable in design 400 may be square, rectangular or circular (round) in general. Referring to FIG. 4, each core may be placed at a 90° angle relative to its adjacent cores (e.g., those cores that are directly above, below, to the left, and to the right of the given core as shown in a top view or cross-sectional view of the DWG cable in FIG. 4) while being at a 0° angle relative to its diagonal cores (e.g., those cores that are to the upper-left, upper-right, lower-left, and lower-right of the given core as shown in a top view or cross-sectional view of the DWG cable in FIG. 4). That is, as the cross section of each core may have a generally elongated or rectangular shape with two longer sides and two shorter sides, in the cross-sectional view of the DWG cable each core may be oriented at 90° relative to (e.g., perpendicular to) its adjacent cores and at 0° relative to (e.g., parallel to) its diagonal cores. The center-to-center spacing between two adjacent cores may be chosen to achieve a good electrical isolation. The material of the cladding may be chosen to provide sufficient protection of the cores against external contact while providing insulation/isolation. Moreover, the cladding dielectric may have a round or circular cross section around each core of the plurality of cores. In design 400, the DWG cable may have an even or odd number of cores such as, for example and not limited to, 4 or 6 or 8 or 9 or 10 or 12 or 14 or 16 or 18 or 20 or 22 cores, and so on, with the example case of 6 cores shown in FIG. 4.

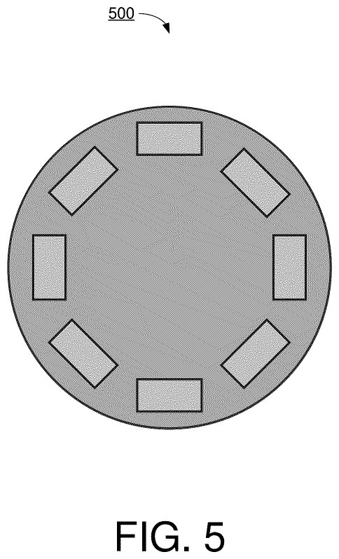

FIG. 5 illustrates an example design 500 of a DWG cable under a proposed scheme in accordance with the present disclosure. In design 500, the DWG cable may have a round or circular cross section. Referring to FIG. 5, the plurality of cores (or core dielectrics) may be disposed around a circumference of the DWG cable with each core placed at a 45° angle relative to its adjacent cores (e.g., those cores that are immediately next to the given core in both directions around the circumference of the DWG cable as shown in a top view or cross-sectional view of the DWG cable in FIG. 5). The material of the cladding may be chosen to provide sufficient protection of the cores against external contact while providing insulation/isolation. Moreover, cladding dielectric may be filled everywhere else in the entire cable for ease of manufacturability. In design 500, the DWG cable may have an even or odd number of cores such as, for example and not limited to, 8 or 9 or 10 or 12 or 14 or 16 or 18 or 20 or 22 cores, and so on, with the example case of 8 cores shown in FIG. 5.

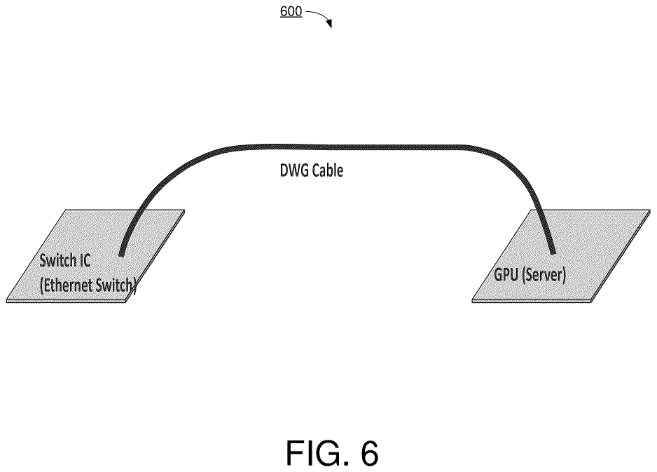

FIG. 6 illustrates an example scenario 600 under a proposed scheme in accordance with the present disclosure. Scenario 600 may pertain to a use-case scenario in which a DWG cable may be utilized in high rate data communications. Referring to FIG. 6, the DWG cable may be used to connect a GPU (e.g., in a server) and a switch IC (e.g., in an ethernet switch) in a data center.

As an implementational example, for a frequency range from 125 - 170 GHz, the supported bandwidth may be 45 GHz. If 16-quadrature amplitude modulation (16-QAM) is supported by a chipset, the data rate of one waveguide may be 180 Gbps. For one implementation, the DWG cable may have 18 waveguides (e.g., arranged in an array of 3 rows×6 columns). Each waveguide may support a 180 Gbps link, resulting in a bi-directional data rate carried by the DWG cable to be 3.2 Tbps. The core dielectric may have a 2 mm by 1 mm cross-section. The center-to-center spacing between adjacent waveguides may be kept as 7 mm. Correspondingly, the spacing between diagonal waveguides may be 10 mm, which may be sufficient to achieve good isolation over a length of 3 meters. Moreover, a width of the DWG cable may be 40 mm and a height of the DWG cable may be 19 mm.

Accordingly, a dielectric waveguide cable under one or more of the proposed designs may provide benefits over conventional electrical and optical interconnect. For instance, compared to electrical copper cables, a dielectric waveguide cable under one or more of the proposed designs may offer minimal roll-off in insertion loss over the channel bandwidth. Compared to optical cables, a dielectric waveguide cable under one or more of the proposed designs may offer a cheaper solution. In the various designs, a dielectric waveguide cable may include multiple core dielectrics (lanes), with each core dielectric (lane) configured to carry multiple data streams to support an overall high data rate communication. As isolation of one core dielectric (lane) to another is an extremely important parameter to suppress crosstalk and hence noise floor, in the various designs adjacent core dielectrics (lanes) may be aligned in 90-degrees relative orientation, to improve the isolation. Moreover, diagonal core dielectrics (lanes) may be aligned in 0-degree relative orientation. In the various designs, cladding dielectric may be filled everywhere else in the entire cable. The proposed structure may provide manufacturability ease and hence may lower the cost of manufacturing. Additionally, the proposed structure may provide a tight control over core locations, thereby achieving good isolation for long distance, including twisting and bending of the DWG cable.

### Feature Highlights

In view of the above, select features of the various proposed designs are summarized below.

In one aspect, a device may include a DWG cable configured to carry multiple data streams to support a high data rate communication. The DWG cable may include a cladding material and a plurality of cores with each core of the plurality of cores surrounded by the cladding material.

In another aspect, an apparatus may include two IC chips (e.g., a GPU and a switch-IC) and a DWG cable. The DWG cable may be configured to carry multiple data streams to support a high data rate communication. The DWG cable may include a cladding material and a plurality of cores with each core of the plurality of cores surrounded by the cladding material.

In some implementations, each core of the plurality of cores may be next to one or more adjacent cores of the plurality of cores. Moreover, a cross section of each core of the plurality of cores may be oriented at 90° relative to, or perpendicular to, a respective cross section of each of the one or more adjacent cores. In some implementations, each core of the plurality of cores may also be surrounded by one or more diagonal cores of the plurality of cores. In such cases, the cross section of each core of the plurality of cores may be oriented at 0° relative to, or parallel to, a respective cross section of each of the one or more diagonal cores.

In some implementations, each core of the plurality of cores may be surrounded by one or more diagonal cores of the plurality of cores. Furthermore, a cross section of each core of the plurality of cores may be oriented at 0° relative to, or parallel to, a respective cross section of each of the one or more diagonal cores. In some implementations, each core of the plurality of cores may also be next to one or more adjacent cores of the plurality of cores. In such cases, the cross section of each core of the plurality of cores may be oriented at 90° relative to, or perpendicular to, a respective cross section of each of the one or more adjacent cores.

In some implementations, at least one core of the plurality of cores may be next to one or more adjacent cores of the plurality of cores. Additionally, a cross section of the at least one core may be oriented at 45° relative to a respective cross section of each of the one or more adjacent cores.

In some implementations, a cross section of the DWG cable may be generally round or circular in shape.

In some implementations, a cross section of the DWG cable may be generally square, rectangular or circular (round) in shape.

In some implementations, the cladding material may include a cladding dielectric surrounding the plurality of cores and filled everywhere else in the DWG cable.

In some implementations, each core of the plurality of cores may be individually surrounded by a respective portion of the cladding material.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A device, comprising:
a dielectric waveguide (DWG) cable configured to carry multiple data streams to support a high data rate communication, the DWG cable comprising a cladding material and a plurality of cores with each core of the plurality of cores surrounded by the cladding material.

2. The device of claim 1, wherein each core of the plurality of cores is next to one or more adjacent cores of the plurality of cores, and wherein a cross section of each core of the plurality of cores is oriented at 90° relative to, or perpendicular to, a respective cross section of each of the one or more adjacent cores.

3. The device of claim 2, wherein each core of the plurality of cores is surrounded by one or more diagonal cores of the plurality of cores, and wherein the cross section of each core of the plurality of cores is oriented at 0° relative to, or parallel to, a respective cross section of each of the one or more diagonal cores.

4. The device of claim 1, wherein each core of the plurality of cores is surrounded by one or more diagonal cores of the plurality of cores, and wherein a cross section of each core of the plurality of cores is oriented at 0° relative to, or parallel to, a respective cross section of each of the one or more diagonal cores.

5. The device of claim 4, wherein each core of the plurality of cores is next to one or more adjacent cores of the plurality of cores, and wherein the cross section of each core of the plurality of cores is oriented at 90° relative to, or perpendicular to, a respective cross section of each of the one or more adjacent cores.

6. The device of claim 1, wherein at least one core of the plurality of cores is next to one or more adjacent cores of the plurality of cores, and wherein a cross section of the at least one core is oriented at 45° relative to a respective cross section of each of the one or more adjacent cores.

7. The device of claim 1, wherein a cross section of the DWG cable is generally round or circular in shape.

8. The device of claim 1, wherein a cross section of the DWG cable is generally square, rectangular or circular in shape.

9. The device of claim 1, wherein the cladding material comprises a cladding dielectric surrounding the plurality of cores and filled everywhere else in the DWG cable.

10. The device of claim 1, wherein each core of the plurality of cores is individually surrounded by a respective portion of the cladding material.

11. An apparatus, comprising:
two integrated circuit (IC) chips; and
a dielectric waveguide (DWG) cable configured to carry multiple data streams to support a high data rate communication between the two IC chips, the DWG cable comprising a cladding material and a plurality of cores with each core of the plurality of cores surrounded by the cladding material.

12. The apparatus of claim 11, wherein each core of the plurality of cores is next to one or more adjacent cores of the plurality of cores, and wherein a cross section of each core of the plurality of cores is oriented at 90° relative to, or perpendicular to, a respective cross section of each of the one or more adjacent cores.

13. The apparatus of claim 12, wherein each core of the plurality of cores is surrounded by one or more diagonal cores of the plurality of cores, and wherein the cross section of each core of the plurality of cores is oriented at 0° relative to, or parallel to, a respective cross section of each of the one or more diagonal cores.

14. The apparatus of claim 11, wherein each core of the plurality of cores is surrounded by one or more diagonal cores of the plurality of cores, and wherein a cross section of each core of the plurality of cores is oriented at 0° relative to, or parallel to, a respective cross section of each of the one or more diagonal cores.

15. The apparatus of claim 14, wherein each core of the plurality of cores is next to one or more adjacent cores of the plurality of cores, and wherein the cross section of each core of the plurality of cores is oriented at 90° relative to, or perpendicular to, a respective cross section of each of the one or more adjacent cores.

16. The apparatus of claim 11, wherein at least one core of the plurality of cores is next to one or more adjacent cores of the plurality of cores, and wherein a cross section of the at least one core is oriented at 45° relative to a respective cross section of each of the one or more adjacent cores.

17. The apparatus of claim 11, wherein a cross section of the DWG cable is generally round or circular in shape.

18. The apparatus of claim 11, wherein a cross section of the DWG cable is generally square, rectangular or circular in shape.

19. The apparatus of claim 11, wherein the cladding material comprises a cladding dielectric surrounding the plurality of cores and filled everywhere else in the DWG cable.

20. The apparatus of claim 11, wherein each core of the plurality of cores is individually surrounded by a respective portion of the cladding material.
